(19) United States
(12) Patent Application Publication
(10) Pub. No.: US 2026/0312181 A1
(43) Pub. Date: Oct. 8, 2026

(54) TRACTION BATTERY PACK THERMAL ARRAY-TO-ARRAY BARRIER

(71) Applicant: Ford Global Technologies, LLC, Dearborn, MI (US)

(72) Inventors: Claudia Olivia Iyer, Bloomfield Hills, MI (US); Di Zhu, Novi, MI (US); Jianwen Yi, West Bloomfield, MI (US); Liwen Zhang, Novi, MI (US); Xinlei Zhou, Canton, MI (US)

(21) Appl. No.: 19/172,765

(22) Filed: Apr. 8, 2025

(51) Int. Cl. H01M 10/658; H01M 10/625; H01M 10/6554; H01M 50/204; H01M 50/249; H01M 50/262

(52) U.S. Cl. CPC H01M 10/658; H01M 10/625; H01M 10/6554; H01M 50/204; H01M 50/249; H01M 50/262; H01M 2220/20

(57) ABSTRACT

In some aspects, the techniques described herein relate to a traction battery pack assembly, including: first and second battery arrays within an interior of an enclosure, the first and second battery arrays each including a plurality of battery cells; and an array-to-array barrier spanning between the first and second battery arrays, the array-to-array barrier having a first upright section adjacent the first battery array, a second upright section adjacent the second battery array, and a base section connecting the first and second upright sections.

### TECHNICAL FIELD

This disclosure relates generally to thermal barriers for a traction battery pack and, more particularly, to inter-array barriers that have upright sections extending from a base section.

### BACKGROUND

A traction battery pack of an electrified vehicle can include groups of battery cells arranged in one or more cell stacks. The traction battery pack includes a plurality of battery cells and various other battery internal components that support electric vehicle propulsion. During a thermal event, battery cells can vent.

### SUMMARY

In some aspects, the techniques described herein relate to a traction battery pack assembly, including: first and second battery arrays within an interior of an enclosure, the first and second battery arrays each including a plurality of battery cells; and an array-to-array barrier spanning between the first and second battery arrays, the array-to-array barrier having a first upright section adjacent the first battery array, a second upright section adjacent the second battery array, and a base section connecting the first and second upright sections.

In some aspects, the techniques described herein relate to an assembly, wherein the first upright section and the second upright section extend vertically upward from respective first and second sides of the base section.

In some aspects, the techniques described herein relate to an assembly, further including a thermal exchange plate, the first and second battery arrays disposed on the thermal exchange plate, the base section elevated above the thermal exchange plate to provide an open area between the base section and the thermal exchange plate.

In some aspects, the techniques described herein relate to an assembly, further including endplates of the first and second battery arrays, the first upright section interfacing directly with the endplate of the first battery array, the second upright section interfacing directly with the endplate of the second battery array.

In some aspects, the techniques described herein relate to an assembly, wherein the first upright section is bonded to the endplate of the first battery array, and the second upright section is bonded to the endplate of the second battery array.

In some aspects, the techniques described herein relate to an assembly, wherein the first upright section is secured to the endplate of the first battery array through at least one first mechanical fastener, and the second upright section is secured to the endplate of the second battery array through at least one second mechanical fastener.

In some aspects, the techniques described herein relate to an assembly, wherein the array-to-array barrier further includes a first lip extending from the first upright section over at least some of the first battery array, and a second lip extending from the second upright section over at least some of the second battery array.

In some aspects, the techniques described herein relate to an assembly, wherein the array-to-array barrier is U-shaped.

In some aspects, the techniques described herein relate to an assembly, wherein the array-to-array barrier is a hot-pressed array-to-array barrier.

In some aspects, the techniques described herein relate to an assembly, wherein the array-to-array barrier is mica.

In some aspects, the techniques described herein relate to an assembly, wherein the first upright section and the second upright section are thicker than the base section.

In some aspects, the techniques described herein relate to an assembly, wherein the first upright section and the second upright section each include more layers of material than the base section.

In some aspects, the techniques described herein relate to an assembly, wherein the first and second upright sections are parallel.

In some aspects, the techniques described herein relate to an assembly, wherein the first and second upright sections are oriented transverse to the base section.

In some aspects, the techniques described herein relate to a traction battery pack assembly, including: first and second arrays each having a plurality of individual battery cells disposed between first and second endplates; and an inter-array thermal barrier attached to both the first array and the second array.

In some aspects, the techniques described herein relate to a traction battery pack assembly, wherein the inter-array thermal barrier includes a first upright section extending upward from a first side of a base section, and a second upright section extending upward from an opposite, second side of the base section.

In some aspects, the techniques described herein relate to a traction battery pack assembly, wherein a first lip of the inter-array thermal barrier extends from the first upright section in a first direction across an upper surface of the first array, wherein a second lip of the inter-array thermal barrier extends in an opposite, second direction across an upper surface of the second array.

In some aspects, the techniques described herein relate to a traction battery pack assembly, wherein the first lip and the second lip are parallel to the base section.

In some aspects, the techniques described herein relate to a traction battery pack assembly, wherein the base section is elevated above a thermal exchange plate to provide an open area between the thermal exchange plate and the base section, the plurality of individual battery cells disposed atop the thermal exchange plate.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle.

FIG. 2 illustrates an expanded view of a traction battery pack from the electrified vehicle of FIG. 1 according to an exemplary embodiment of the present disclosure.

FIG. 3 illustrates a section view taken at line 3–3 in FIG. 2 showing an inter-array thermal barrier between two arrays of the traction battery pack.

FIG. 4 illustrates a perspective view of the inter-array thermal barrier of FIG. 3.

FIG. 5 illustrates a section view at the line 3–3 of FIG. 3 but with an inter-array thermal barrier according to another exemplary aspect of the present disclosure.

FIG. 6 illustrates a section view at the line 3–3 of FIG. 3 but with an inter-array thermal barrier according to yet another exemplary aspect of the present disclosure.

### DETAILED DESCRIPTION

This disclosure details exemplary array-to-array barriers used within a traction battery assembly. In particular, the disclosure describes array-to-array barriers that have upright sections extending from opposite sides of a base section.

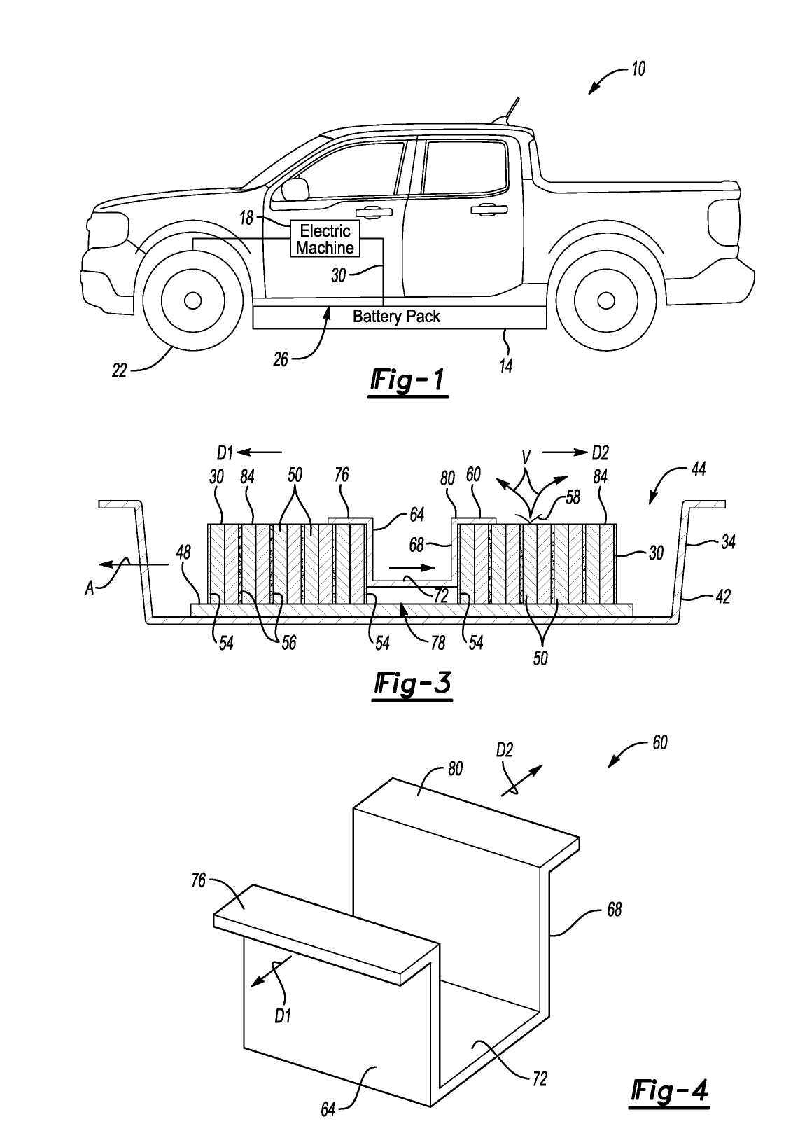

With reference to FIG. 1, an electrified vehicle 10 includes a battery pack 14, an electric machine 18, and wheels 22. The battery pack 14 powers the electric machine 18, which can convert electrical power to mechanical power to drive the wheels 22.

The battery pack 14 is, in the exemplary embodiment, secured to an underbody 26 of the electrified vehicle 10. The battery pack 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a battery pack.

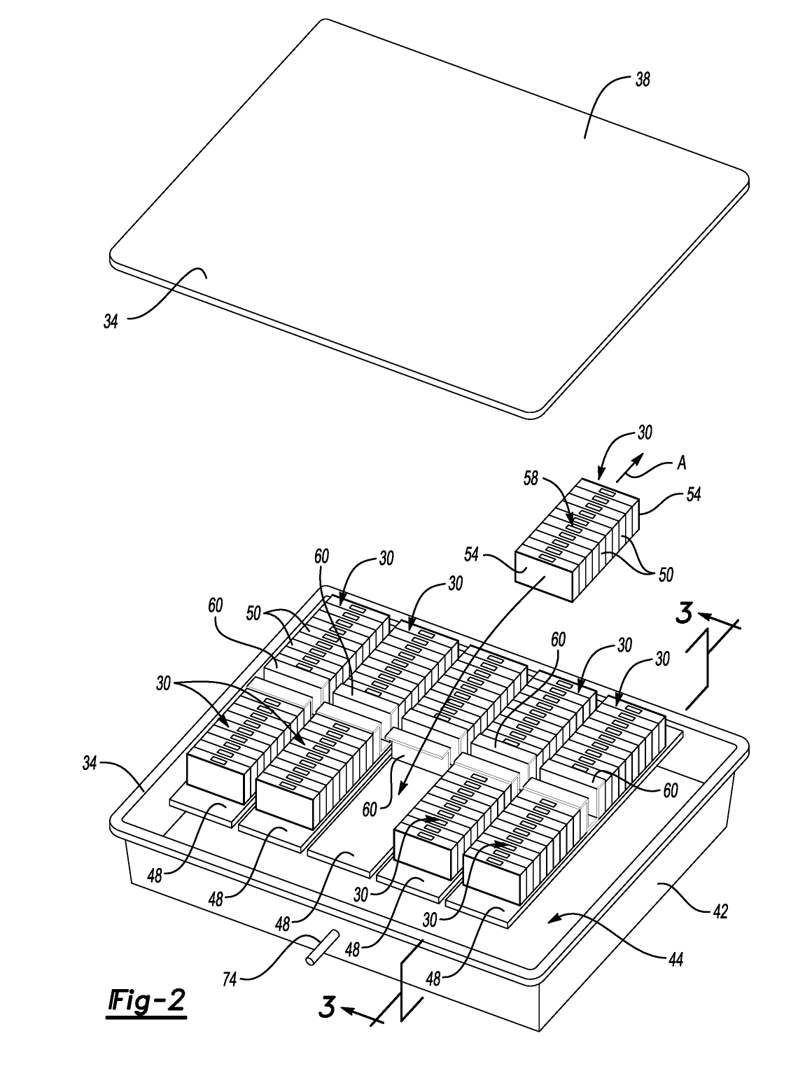

With reference now to FIGS. 2 to 4, the battery pack 14 includes a plurality of battery arrays 30 held within a battery pack enclosure 34. In the exemplary embodiment, the enclosure 34 includes an enclosure cover 38 and an enclosure tray 42. The enclosure cover 38 can be secured to the enclosure tray 42 using mechanical fasteners, for example. The enclosure cover 38 is secured to the enclosure tray 42 to provide an interior 44 that houses the battery arrays 30.

Within the interior 44, the batteries arrays 30 are disposed on one or more thermal exchange plates 48. Coolant can be circulated through the thermal exchange plates 48 to manage thermal energy levels of components of the battery arrays 30.

Each of the battery arrays 30 includes a plurality of battery cells 50 (or simply, “cells”) stacked side-by-side relative to each other along a respective cell stack axis Aand sandwiched between endplates 54. In addition to the battery cells 50 and endplates 54, the arrays 30 can include thermal barriers 56 that are, for example, disposed between the battery cells 50. These thermal barriers 56 can be considered intra-array thermal barriers or cell-to-cell thermal barriers.

The battery cells 50 store and supply electrical power. Although specific numbers of the battery arrays 30 and cells 50 are illustrated in the various figures of this disclosure, the battery pack 14 could include any number of the battery arrays 30 having any number of individual cells 50.

In an embodiment, the battery cells 50 are lithium-ion pouch cells. However, battery cells having other geometries (cylindrical, prismatic, etc.) other chemistries (nickel-metal hydride, lead-acid, etc.), or both could alternatively be utilized within the scope of this disclosure.

From time to time, pressure and thermal energy within one or more of the battery cells 50 in the battery pack 14 can increase. This can lead to the battery cells 50 expelling vent byproducts V, which can include gas and debris. One of the battery cells 50 in FIG. 3 is shown expelling vent byproducts V.

The vent byproducts V can be expelled from the associated battery cell 50 through a designated vent 58 within the housing of the battery cell 50, such as a membrane that yields in response to increased pressure, or through a ruptured area of the associated battery cell 50.

The example battery pack 14 includes a plurality of thermal barriers 60 that are outside of the arrays 30, but adjacent to the arrays 30. The example thermal barriers 60 can be considered array-to-array thermal barriers or inter-array thermal barriers as the thermal barriers 60 are between separate battery arrays 30 and are not a constituent of any of the arrays 30.

The thermal barriers 60 span between one of the arrays 30 and another of the arrays 30 within an interior of the battery pack enclosure 34. The thermal barriers 60 include a first upright section 64, a second upright section 68, and a base section 72 that connects the first upright section 64 to the second upright section 68. The first upright section 64 and the second upright section 68 extend upwards from opposing sides of the base section 72 and are transverse to the base section 72. This gives the thermal barrier 60 a U-shape, which can, among other things, facilitate installation.

The first upright section 64 and the second upright section 68 of the example thermal barrier 60 are parallel to each other, and are perpendicular to the base section 72. The first upright section 64 and the second upright section 68 are oriented vertically whereas the base section 72 is oriented horizontally. Vertical is, for purposes of this disclosure, with reference to ground and general orientation of battery pack 14 when installed on the vehicle 10.

The thermal barrier 60 can be formed from a single sheet of material, such as single sheet of mica. The sheet can be hot-pressed to provide the U-shape. A thermal barrier that is hot-pressed from a sheet of material is structurally distinguishable from a thermal barrier that is not hot-pressed, such as a thermal barrier that is assembled from several separate pieces.

In the exemplary embodiment, the thermal barrier 60 includes a first lip 76 that extends in a first axial direction D1 from an upper edge of the first upright section 64, and a second lip 80 extends in a second axial direction D2 from an upper edge of the second upright section 68. The first lip 76 and the second lip 80 are parallel to the base section 72. The first lip 76 and the second lip 80 each extend across an upper surface 84 of the associated array 30.

Within the interior of the battery pack enclosure 34, the thermal barriers 60 are positioned such that the first upright section 64 interfaces directly with the endplate 54 of one of the battery arrays 30, and the second upright section 68 interfaces directly with the endplate 54 of another of the arrays 30.

The first upright section 64 and the second upright section 68 can shield the endplates 54 and other areas of the arrays 30 from vent byproducts V released from battery cells 50. The first upright section 64 and the second upright section 68 can, for example, block particulates within the vent byproducts V from impinging on the endplates 54, which could add thermal energy to that array 30 and potentially lead to more cells 50 venting. The vent byproducts V can eventually be discharged from the interior 44 through an enclosure vent 74 to an area surrounding the battery pack 14.

The base section 72 of the thermal barrier 60 spans between the first upright section 64 and the second upright section 68. The base section 72 can cover areas of the thermal exchange plate 48. In the exemplary embodiment, the base section 72 can be elevated above the thermal exchange plate 48 to provide an open area 78 between the thermal barrier 60 and the thermal exchange plate 48. In other examples, the base section 72 can rest directly on the thermal exchange plate 48.

If vent byproducts V are expelled from any of the cells 50 with the battery pack 14, the base section 72 can block those vent byproducts V from contacting the thermal exchange plate 48. Elevating the base section 72 from the thermal exchange plate 48 can inhibit a transfer of thermal energy from the vent byproducts V through the base section 72 to the thermal exchange plate 48. Elevating the base section 72 can also help to mitigate vibration issues.

To secure or attach the thermal barriers 60 within the battery pack 14, the first upright section 64 and the second upright section 68 can be adhesively bonded to the associated endplates 54. In other examples, at least one mechanical fastener could instead or additionally be used to secure the first upright section 64 and the second upright section 68 to the associated endplates 54. The mechanical fasteners could be push pins or screws.

The first lip 76 and the second lip 80 can be secured to the associated array 30 with an adhesive, mechanical fasteners, or with some combination of these. The first lip 76 and the second lip 80 can be secured to the associated arrays 30 instead of, or in addition to securing the first upright section 64 and the second upright section 68 to the associated array 30.

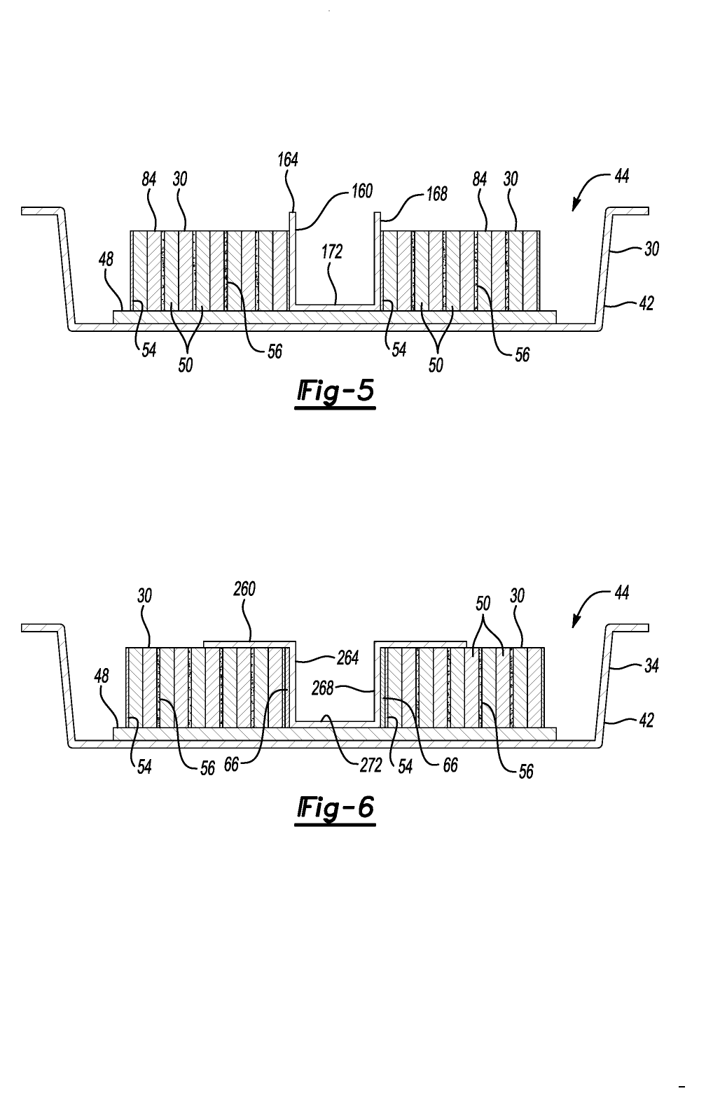

With reference now to FIG. 5, a thermal barrier 160 according to another exemplary aspect of this disclosure includes a first upright section 164 and a second upright section 168 connected by a base section 172 but does not include any lips extending over the upper surface 84 of the associated array 30. The base section 172 can rest on the thermal exchange plate 48 as shown or be elevated.

With reference now to FIG. 6, a thermal barrier 260 according to yet another exemplary aspect of this disclosure includes a first upright section 264 and a second upright section 268 connected by a base section 272. A second layer of material 66 is sandwiched between the first upright section 264 and its associated array 30, and between the second upright section 268 and its associated array 30. This effectively makes the first upright section 264 and the second upright section 268 thicker than the base section 272. The thickness can be a double thickness in some examples. The second layer of material 66 can be the same material as the thermal barrier 260. That is, the layers of material 66 and the thermal barrier 260 can both be mica, for example. The base section 272 can rest on the thermal exchange plate 48 as shown or be elevated.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery pack assembly, comprising:
first and second battery arrays within an interior of an enclosure, the first and second battery arrays each including a plurality of battery cells; and
an array-to-array barrier spanning between the first and second battery arrays, the array-to-array barrier having a first upright section adjacent the first battery array, a second upright section adjacent the second battery array, and a base section connecting the first and second upright sections.

2. The assembly of claim 1, wherein the first upright section and the second upright section extend vertically upward from respective first and second sides of the base section.

3. The assembly of claim 1, further comprising a thermal exchange plate, the first and second battery arrays disposed on the thermal exchange plate, the base section elevated above the thermal exchange plate to provide an open area between the base section and the thermal exchange plate.

4. The assembly of claim 1, further comprising endplates of the first and second battery arrays, the first upright section interfacing directly with the endplate of the first battery array, the second upright section interfacing directly with the endplate of the second battery array.

5. The assembly of claim 4, wherein the first upright section is bonded to the endplate of the first battery array, and the second upright section is bonded to the endplate of the second battery array.

6. The assembly of claim 4, wherein the first upright section is secured to the endplate of the first battery array through at least one first mechanical fastener, and the second upright section is secured to the endplate of the second battery array through at least one second mechanical fastener.

7. The assembly of claim 1, wherein the array-to-array barrier further includes a first lip extending from the first upright section over at least some of the first battery array, and a second lip extending from the second upright section over at least some of the second battery array.

8. The assembly of claim 1, wherein the array-to-array barrier is U-shaped.

9. The assembly of claim 1, wherein the array-to-array barrier is a hot-pressed array-to-array barrier.

10. The assembly of claim 1, wherein the array-to-array barrier is mica.

11. The assembly of claim 1, wherein the first upright section and the second upright section are thicker than the base section.

12. The assembly of claim 11, wherein the first upright section and the second upright section each include more layers of material than the base section.

13. The assembly of claim 1, wherein the first and second upright sections are parallel.

14. The assembly of claim 1, wherein the first and second upright sections are oriented transverse to the base section.

15. A traction battery pack assembly, comprising:
first and second arrays each having a plurality of individual battery cells disposed between first and second endplates; and
an inter-array thermal barrier attached to both the first array and the second array.

16. The traction battery pack assembly of claim 15, wherein the inter-array thermal barrier includes a first upright section extending upward from a first side of a base section, and a second upright section extending upward from an opposite, second side of the base section.

17. The traction battery pack assembly of claim 16, wherein a first lip of the inter-array thermal barrier extends from the first upright section in a first direction across an upper surface of the first array, wherein a second lip of the inter-array thermal barrier extends in an opposite, second direction across an upper surface of the second array.

18. The traction battery pack assembly of claim 17, wherein the first lip and the second lip are parallel to the base section.

19. The traction battery pack assembly of claim 16, wherein the base section is elevated above a thermal exchange plate to provide an open area between the thermal exchange plate and the base section, the plurality of individual battery cells disposed atop the thermal exchange plate.
